(19) United States
(12) Patent Application Publication
(10) Pub. No.: US 2026/0310172 A1
(43) Pub. Date: Oct. 8, 2026

(54) SCADA WEB HMI SYSTEM

(71) Applicant: TMEIC Corporation, Tokyo (JP)

(72) Inventors: Ryo SHIMIZU, Tokyo (JP); Akira NOJIMA, Tokyo (JP); Nobuo SHIMIZU, Tokyo (JP)

(73) Assignee: TMEIC Corporation, Tokyo (JP)

(21) Appl. No.: 19/100,935

(22) PCT Filed: Aug. 4, 2023
(86) PCT No.: PCT/JP2023/028568

§ 371 Date: Feb. 4, 2025

(51) Int. Cl. G05B 19/4155

(52) U.S. Cl. CPC G05B 19/4155; G05B 2219/32404

(57) ABSTRACT

A server memory stores image data, screen operation authority information and part operation authority information. The screen operation authority information defines operation permission/prohibition of HMI screen, based on an operation place. The part operation authority information defines operation permission/prohibition of each of specific operation parts on each HMI screen, based on duty of an operator. A server processor executes a web server capable of transmitting the image data, the screen operation authority information and the part operation authority information to. A client memory stores the image data, the screen operation authority information and the part operation authority information. A client processor draws the HMI screen on web browser by applying the operation permission/prohibition defined in the screen operation authority information to operation parts on the HMI screen and preferentially applying the operation permission/prohibition defined based on the duties in the part operation authority information, to the specific operation parts.

### TECHNICAL FIELD

The present disclosure relates to a SCADA web HMI system.

### BACKGROUND ART

A SCADA (Supervisory Control And Data Acquisition) is known as a mechanism supervising and controlling a social infrastructure system. The social infrastructure system includes a steel rolling system, a power transmission and transformation system, a water and sewage treatment system, a building management system, a road system, and the like.

The SCADA is a type of industrial control system, and performs system supervision, process control, and data collection by a computer. The SCADA requires quick responsiveness (real-time property) corresponding to processing performance of the system.

The SCADA includes, as sub-systems, an HMI (Human Machine Interface), a supervisory control system, a remote input/output device (Remote Input Output: RIO), and a communication base.

The HMI is a mechanism that presents data on a supervisory object device to an operator, and enables the operator to supervise and control the supervisory object device. The supervisory control system includes a Programmable Logic Controller (PLC) and the like. The supervisory control system collects data on the supervisory object device, and transmits a control command to the supervisory object device. The remote input/output device is connected to a sensor installed in the supervisory object device, converts a signal of the sensor into digital data, and transmits the digital data to the supervisory control system. The communication base connects the supervisory control system and the remote input/output device.

As an example of a SCADA HMI sub-system, PTL 1 discloses a system including HMI client devices and an HMI server device. In the existing SCADA disclosed in PTL 1, the HMI server device transmits data received from the PLC to each of the HMI client devices. Each of the HMI client devices includes a computer main body, input devices such as a keyboard and a mouse, and a monitor, and displays one HMI screen on the monitor. Note that the applicant is aware of PTL 2 described below as a literature relating to the present disclosure.

In the HMI sub-system according to PTL 1, one HMI client device is necessary to display one HMI screen. In terms of reduction in cost, installation space, failure rate, and communication load, it is desirable to simultaneously use a plurality of HMI screens on one HMI client device.

### CITATION LIST

### Patent Literature

[PTL 1] JP 2017-27211 A
[PTL 2] JP 2019-114090 A

### SUMMARY OF THE INVENTION

### Problems to Be Solved by the Invention

As a result of intensive research, the inventor of the present application has developed a browser-based SCADA HMI sub-system. The browser-based SCADA HMI sub-system can realize an HMI screen as a web application operating on a web browser. Accordingly, a plurality of web browsers can be executed on one HMI client device, and the HMI screen can be displayed on each of the web browsers.

Application of such a browser-based SCADA HMI sub-system to a production line of an industrial plant is considered. In a large-scale plant such as an industrial plant, a production line is divided into a plurality of sections, and an operation room (pulpit) is provided in each of the sections. An HMI client device that executes the web browser drawing the HMI screen is installed in each of the operation rooms. An HMI server device that executes a web server communicating with each of the web browsers is installed in an electric room.

On the web browser of the HMI client device in a first section, an HMI screen relating to facility devices of the first section should be made operable, whereas on the web browser of the HMI client device in a second section, an HMI screen relating to facility devices of the second section should be made operable. Therefore, operation authority is basically set for each of the HMI screens displayed on the web browsers of the HMI client devices, based on operation places of the HMI client devices, namely, based on the sections where the HMI client devices are installed.

However, it was determined that setting of operation permission/prohibition for each of the HMI screens based on the operation places of the HMI client devices is not sufficient, and safety of the supervised facility devices, furthermore, safety of the industrial plant may be impaired. For example, a plurality of operators operating the HMI screens do not always have the same duty (duties), and the plurality of operators may have different duty (duties). In this case, some operation parts (specific operation parts) among a plurality of operation parts on each of the HMI screens are required to be made operable by a person in charge of operation but to be made inoperable by a person in charge of facility. To meet the requirement, it is necessary to set more precise operation authority for each of the HMI screens.

The present disclosure is made to solve the above-described issues. An object of the present disclosure is to provide a SCADA web HMI system in which operation authority can be set for each of HMI screens based on duty of an operator while operation authority is basically set for each of the HMI screens based on operation places of HMI client devices.

### Solution to Problem

A first aspect of the present disclosure relates to a SCADA web HMI system. The SCADA web HMI system comprises an HMI server device configured to execute a web server, and a plurality of HMI client devices each configured to execute at least one web browser communicating with the web server. The HMI server device includes a server processor and a server memory. The server memory stores image data on an HMI screen for supervising an industrial plant, screen operation authority information, and part operation authority information. The screen operation authority information defines operation permission/prohibition of the HMI screen for each HMI screen displayed on the web browser, based on operation places of the HMI client devices. The part operation authority information defines operation permission/prohibition of each of specific operation operation parts as a part of a plurality of operation parts on the HMI screen, for each HMI screen displayed on the web browser, based on duty (duties) of an operator of the HMI client devices. The server processor is configured to execute the web server capable of transmitting the image data, the screen operation authority information, and the part operation authority information to the web browser. Each of the HMI client devices includes a client processor, a client memory, and a monitor. The client memory stores the image data, the screen operation authority information, and the part operation authority information received from the web server. The client processor is configured to execute the web browser displayed on the monitor, and to perform screen drawing processing. The screen drawing processing draws the HMI screen on the web browser by applying the operation permission/prohibition defined in the screen operation authority information to the plurality of operation parts on the HMI screen and preferentially applying the operation permission/prohibition defined based on the duty in the part operation authority information, to each of the specific operation parts on the HMI screen.

A second aspect further includes the following characteristics in addition to the first aspect. The screen operation authority information further defines the operation permission/prohibition of the HMI screen for each HMI screen displayed on the web browser, based on the duty of the operator of the HMI client devices. The part operation authority information further defines the operation permission/prohibition of each of the specific operation parts as a part of the plurality of operation parts on the HMI screen, for each HMI screen displayed on the web browser, based on the operation places of the HMI client devices.

A third aspect further includes the following characteristics in addition to the first or the second aspect. In the screen drawing processing, in a case where operation of the HMI screen on the web browser is permitted in the screen operation authority information, and operation of the specific operation parts on the web browser is not permitted in the part operation authority information, the specific operation parts are drawn in an inoperable state on the web browser, and the operation parts other than the specific operation parts among the plurality of operation parts are drawn in an operable state on the web browser.

A fourth aspect further includes the following characteristics in addition to the first or the second aspect. In the screen drawing processing, in a case where operation of the HMI screen on the web browser is not permitted in the screen operation authority information, and operation of the specific operation parts on the web browser is permitted in the part operation authority information, the specific operation parts are drawn in an operable state on the web browser, and the operation parts other than the specific operation parts among the plurality of operation parts are drawn in an inoperable state on the web browser.

### Advantageous Effects of the Invention

According to the present disclosure, when the HMI screen is drawn on the web browser, the operation permission/prohibition defined in the screen operation authority information is applied to the plurality of operation parts on the HMI screen, and the operation permission/prohibition defined based on the duty (duties) in the part operation authority information is preferentially applied to each of the specific operation parts on the HMI screen. Accordingly, the operation authority is set for each HMI screen based on the operation places of the HMI client devices, and the operation authority of each of the specific operation parts on the HMI screen is preferentially set for each HMI screen based on the duty of the operator. As a result, more precise operation authority is set for each HMI screen. This makes it possible to prevent safety of the supervised plant from being impaired.

### BRIEF DESCRIPTION OF DRAWINGS

FIG. 1 is a diagram to explain a configuration example of a hot rolling line to which a SCADA web HMI system according to an embodiment is applied.

FIG. 2 is a block diagram illustrating outlines of functions held by an HMI server device and HMI client devices configuring the SCADA web HMI system.

FIG. 3(a) is a diagram illustrating an example of an HMI screen relating to a roughing mill, and FIG. 3(b) is a diagram illustrating an example of an HMI screen relating to a finishing mill.

FIG. 4 is a diagram illustrating an example of a screen operation authority (operation place) table.

FIG. 5 is a diagram illustrating an example of a screen operation authority (duty) table.

FIG. 6 is a diagram illustrating an example of a part operation authority (operation place) table.

FIG. 7 is a diagram illustrating an example of a part operation authority (duty) table.

FIG. 8 is a flowchart to explain an example of screen drawing processing.

FIG. 9 is a block diagram illustrating a hardware configuration example of the SCADA web HMI system.

### Description of Embodiment

A SCADA web HMI system according to an embodiment of the present disclosure is described with reference to drawings by using a case where the SCADA web HMI system is applied to a hot rolling line RL as an example. The hot rolling line RL is an example of a production line of an industrial system. Note that elements common to the drawings are denoted by the same reference numerals, and repetitive description is omitted.

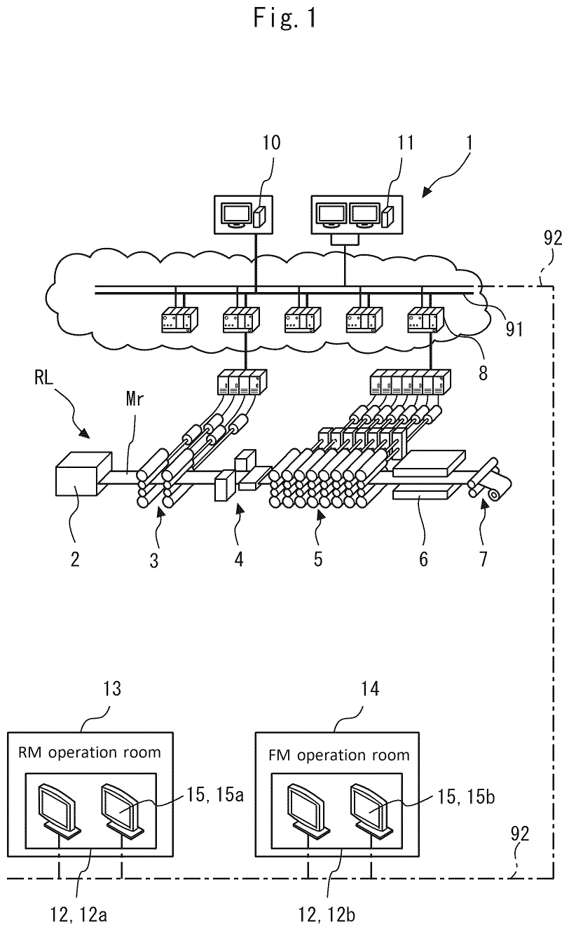

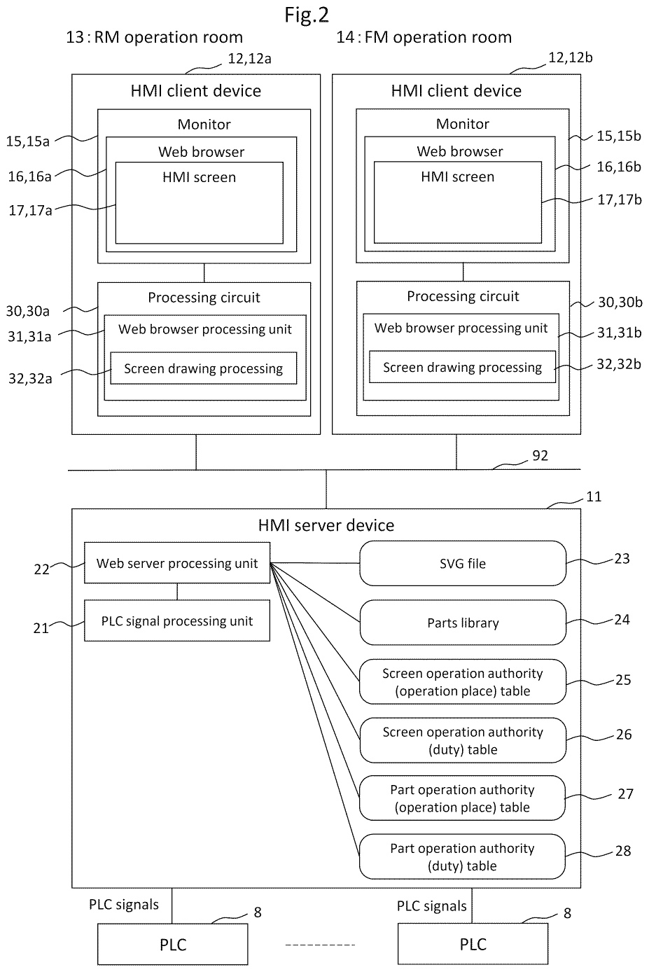

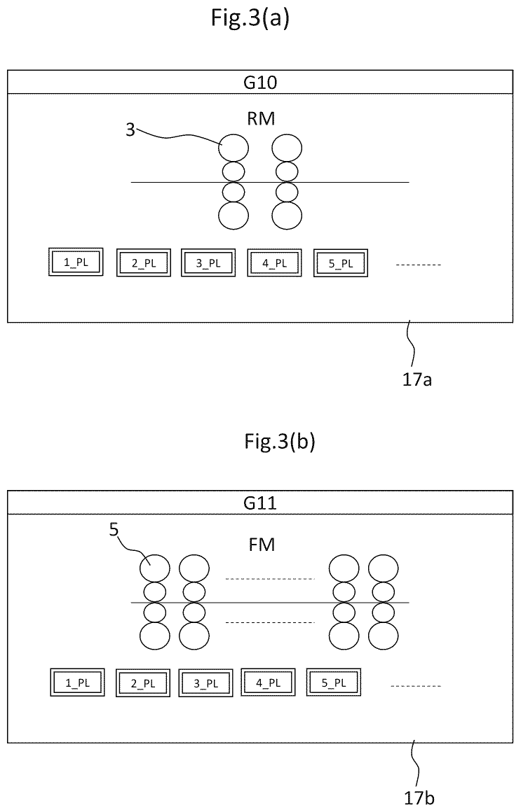

FIG. 1 is a diagram to explain a configuration example of the hot rolling line RL to which a SCADA web HMI system 1 according to the embodiment is applied. FIG. 2 is a block diagram illustrating outlines of functions held by an HMI server device and HMI client devices configuring the SCADA web HMI system. FIG. 3(a) is a diagram illustrating an example of an HMI screen relating to a roughing mill, and FIG. 3(b) is a diagram illustrating an example of an HMI screen relating to a finishing mill.

The hot rolling line RL rolls a material to be rolled Mr such as a metal material, to a desired plate thickness and a desired plate width. The hot rolling line RL includes, as facility devices, a heating furnace 2, a roughing mill 3, an intermediate facility 4, a finishing mill 5, a water-cooling device 6, a coiler 7, and a roller table (not illustrated) conveying the material to be rolled Mr among these devices.

The heating furnace 2 increases a temperature of the material to be rolled Mr. The material to be rolled 1 increased in temperature is extracted onto the roller table. The extracted material to be rolled Mr is a shaped metal block called a slab. The roughing mill 3 is provided on a downstream of the heating furnace 2. The roughing mill 3 includes a single rolling stand or a plurality of (two in present embodiment) rolling stands. The roughing mill 3 rolls the material to be rolled Mr a plurality of times in a forward direction (from upstream to downstream) and an opposite direction (from downstream to upstream).

The intermediate facility 4 is provided between the roughing mill 3 and the finishing mill 5. The intermediate facility 4 includes an edge heater, a bar heater, a coil box, and the like. The finishing mill 5 is provided on a downstream of the intermediate facility 4. The finishing mill 5 includes a plurality of (eight in present embodiment) rolling stands. The finishing mill 5 rolls the material to be rolled Mr in one direction from the upstream to the downstream.

The water-cooling device 6 is provided on a downstream of the finishing mill 5. The water-cooling device 6 pours water onto the rolled material to be rolled Mr, thereby cooling the material to be rolled Mr to a target temperature. The coiler 7 is provided on a downstream of the water-cooling device 6. The material to be rolled Mr cooled by the water-cooling device 6 is coiled by the coiler 7, thereby turning into a coil-shaped product.

The above-described facility devices (2 to 7) each include an actuator such as an electric motor and a drive device. Further, various kinds of sensors (not illustrated) as measurement devices are provided at important points of the rolling line RL. The various kinds of sensors successively measure states of the material to be rolled Mr and the facility devices 2 to 7. These actuators and sensors are connected to PLCs 8 through a control LAN 91. The PLCs 8 are connected to a computer 10 installed in a computer room through the control LAN 91. The computer 10 calculates setting values of the facility devices 2 to 7 based on a rolling plan for the material to be rolled Mr, and transmits the setting values to the PLCs 8. The PLCs 8 control the actuators of the facility devices 2 to 7 based on the setting values received from the computer 10, and control signals received from HMI client devices 12 described below through an HMI server device 11.

The SCADA web HMI system 1 includes the above-described PLCs 8, the HMI server device 11 installed in an electric room, and the HMI client devices 12. The PLCs 8, the HMI server device 11, and the HMI client devices 12 are connected through an information LAN 92 such as Ethernet(R).

Each of the PLCs 8 periodically transmits a packet including block data to the information LAN 92 by multicast or broadcast. The block data is a set of PLC signals. One piece of block data includes several tens to several hundreds of PLC signals. The PLC signals include input/output signals and alarm signals. The input/output signals are generated in response to operation of the HMI client devices 12, and include control signals for controlling the actuators of the facility devices 2 to 7 (hereinafter, also referred to as “actuator control signals”), and detection signals measured by the sensors (hereinafter, also referred to as “sensor detection signals”). Each of the PLCs 8 receives the above-described control signals generated in response to operation of operation parts on HMI screens 17 described below on the HMI client devices 12 from the HMI server device 11.

The hot rolling line RL is divided into a plurality of (two in present embodiment) sections corresponding to the facility devices 2 to 7. Each of the sections includes an operation room (pulpit). A section including the roughing mill 3 includes an RM (Roughing mills) operation room 13. A section including the finishing mill includes an FM (finishing mills) operation room 14. Each of the number of sections and the number of operation rooms may be three or more.

The operation rooms 13 and 14 include HMI client devices 12a and 12b including monitors 15a and 15b, respectively. The monitors 15a and 15b of the HMI client devices 12a and 12b display web browsers 16a and 16b, and display HMI screens 17a and 17b on the displayed web browsers 16a and 16b, respectively. In the present specification, in a case where reference numerals 12a and 15a to 17a are not distinguished from reference numerals 12b and 15b to 17b, the reference numerals 12 and 15 to 17 are simply used.

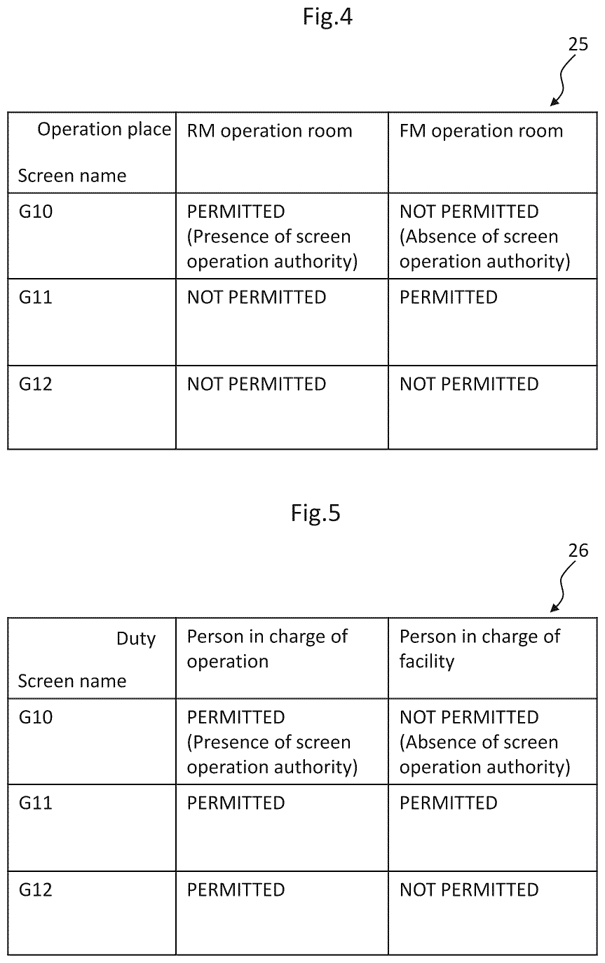

The HMI client device 12a in the RM operation room 13 displays the HMI screen 17a relating to the roughing mill 3 on the web browser 16a, and enables operation of the displayed HMI screen 17a (more specifically, at least one part displayed on HMI screen 17a). The HMI client device 12a can execute the web browser 16b and display the other HMI screen 17b on the web browser 16b; however, the HMI screen 17b is required to be made inoperable on the HMI client device 12a in principle. Likewise, the HMI client device 12b in the FM operation room 14 displays the HMI screen 17b relating to the finishing mill 5 on the web browser 16b, and enables operation of the displayed HMI screen 17b. The HMI client device 12b can execute the web browser 16a and display the other HMI screen 17a on the web browser 16a; however, the HMI screen 17a is required to be made inoperable on the HMI client device 12b in principle. Therefore, in the present embodiment, screen operation authority of each of HMI screens 17 (G10, G11, and G11) is set based on operation places of the HMI client devices 12, by a screen authority (operation place) table 25 illustrated in FIG. 4 described below.

However, a plurality of operators operating the HMI client devices 12 do not always have the same duty (duties), and the plurality of operators may have different duty (duties). The duty include duty relating to operation (operator) for performing manual operation (manual intervention) on the facility devices, duty relating to facilities for performing maintenance including repair of the facility devices and replacement of components, and the like. Among the plurality of HMI screens 17 (G10, G11, and G12) displayed on the HMI client devices 12, the HMI screen 17 (G10) is required to be made operable by a person in charge of operation but to be made inoperable by a person in charge of facility in some cases. Therefore, in the present embodiment, the screen operation authority of each of the HMI screens 17 (G10, G11, and G11) is set based on the duty of the operator logging in the HMI client devices 12, by a screen operation authority (duty) table 26 illustrated in FIG. 5 described below.

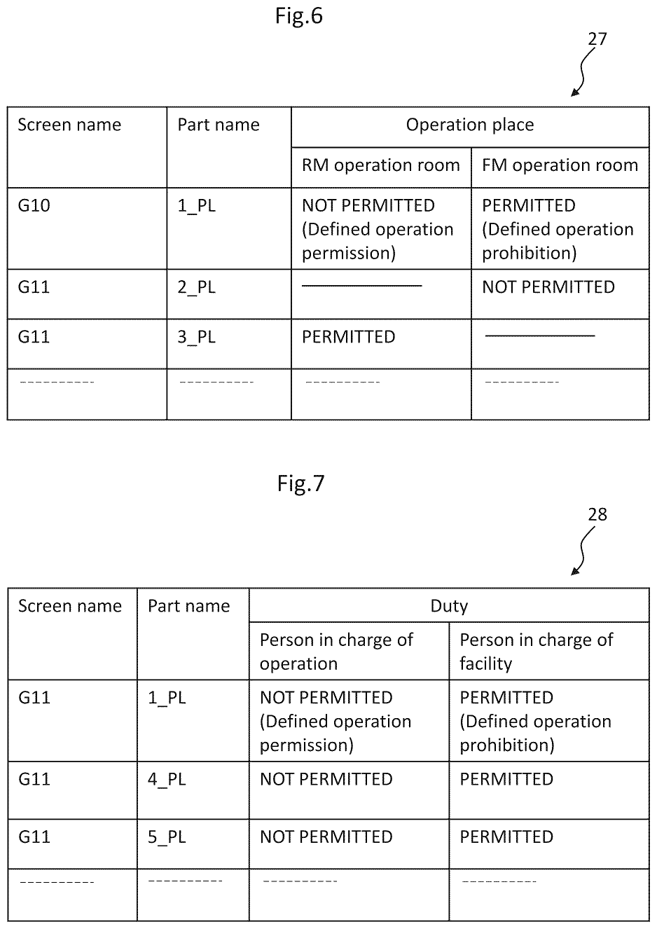

Further, specific operation parts (described below) displayed on the HMI screens 17 are required to be made operable on the HMI client device 12 not having the screen operation authority based on the operation place in some cases. In contrast, the specific operation parts are required to be made inoperable on the HMI client device 12 having the screen based on the operation place in some cases. Therefore, in the present embodiment, the operation authority (operation permission/prohibition) of each of the specific operation parts is set based on the operation place, by a part operation authority (operation place) table 27 illustrated in FIG. 6 described below.

In addition, different operators may operate the same HMI screen 17. For example, specific operation parts for performing manual operation are required to be made operable by the person in charge of operation but to be made inoperable by the person in charge of facility in some cases. For example, specific operation parts for performing maintenance such as roll replacement are required to be made operable by the person in charge of facility but to be made inoperable by the person in charge of operation in some cases. Therefore, in the present embodiment, the operation authority (operation permission/prohibition) of each of the specific operation parts is set based on the duty, by a part operation authority (duty) table 28 illustrated in FIG. 7 described below.

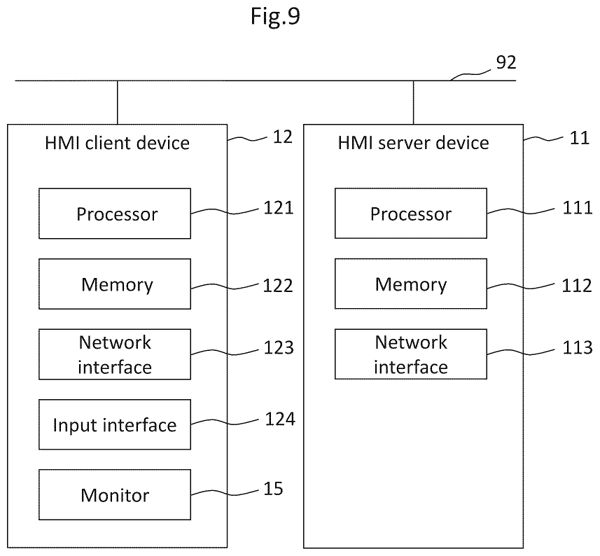

The HMI server device 11 illustrated in FIG. 2 transmits/receives the PLC signals to/from the PLCs 8, and performs a web server. As illustrated in FIG. 9 described below, the HMI server device 11 includes a processor 111 performing various kinds of processing, and a memory 112 storing various kinds of information. The processor 111 and the memory 112 respectively correspond to a server processor and a server memory according to the claims. When the processor 111 executes programs stored in the memory 112, the processor 111 functions as a PLC signal processing unit 21 and a web server processing unit 22. The PLC signal processing unit 21 and the web server processing unit 22 can mutually transmit and receive data through inter-process communication.

The PLC signal processing unit 21 periodically receives the PLC signals including the sensor detection signals from the PLCs 8, and transmits the received PLC signals to web browser processing units 31 (web browsers 16) through the web server processing unit 22. Further, the PLC signal processing unit 21 receives the PLC signals including the actuator control signals from the web browsers 16 of the HMI client devices 12 through the web server processing unit 22, and transmits the received PLC signals to the PLCs 8.

The web server processing unit 22 can communicate with the web browsers 16 (web browser processing units 31) of the HMI client devices 12 by using HTTP (Hypertext Transfer Protocol), HTTPS (Hypertext Transfer Protocol Secure), and WebSocket. The web server processing unit 22 transmits all or a part of contents in response to a request from each of the web browsers 16 (each of web browser processing units 31). The contents include an HTML file (not illustrated), an SVG (Scalable Vector Graphics) file 23 that is image data for each of the HMI screens (HMI Screen) 17, a parts library 24, the screen operation authority (operation place) table 25, the screen operation authority (duty) table 26, the part operation authority (operation place) table 27, and the part operation authority (duty) table 28.

The parts library 24 includes a set of scripts each describing operation for each type of part (hereinafter, referred to as “part type”) displayed on the HMI screens 17. The scripts are JavaScript(R) programs defined for each part type. Parameter values are given to the scripts as necessary, and the scripts can be executed on each of the web browsers 16. The parameter values include, for example, presence/absence of the screen operation authority defined in the screen operation authority (operation place) table 25 and the screen operation authority (duty) table 26, and presence/absence of the specific part operation authority defined in the part operation authority (operation place) table 27 and the part operation authority (duty) table 28.

FIG. 4 is a diagram illustrating an example of the screen operation authority (operation place) table 25. The screen operation authority (operation place) table 25 includes screen operation authority (operation place) information defining presence/absence of the screen operation authority of each of the HMI screens 17 (whether operation is permitted), based on the operation places of the HMI client devices 12a and 12b, more specifically, based on the RM operation room 13 and the FM operation room 14 where the HMI client devices 12a and 12b are respectively installed. “G10” to “G12” are screen names of the HMI screens 17 displayed on the web browsers 16 executed by the respective HMI client devices 12. “G10” is a screen name of the HMI screen 17a illustrated in FIG. 3(a), and “G11” is a screen name of the HMI screen 17b illustrated in FIG. 3(b). In the example illustrated in FIG. 4, the HMI client device 12a operated in the RM operation room 13 has the screen operation authority of the HMI screen 17a (G10) on the web browser 16a, but does not have the screen operation authority of the HMI screens 17 (G11 and G12) on the web browsers 16. The HMI client device 12b operated in the FM operation room 14 has the screen operation authority of the HMI screen 17b (G11) on the web browser 16b, but does not have the operation authority of the HMI screens 17 (G10 and G12) on the web browsers 16.

FIG. 5 is a diagram illustrating an example of the screen operation authority (duty) table 26. The screen operation authority (duty) table 26 includes screen operation authority (duty) information defining presence/absence of the screen operation authority of each of the HMI screens 17 (whether operation is permitted), based on the duty of the operator logging in the HMI client devices 12, more specifically, based on whether the operator is the person in charge of operation or the person in charge of facility. In the example illustrated in FIG. 5, in a case where the person in charge of operation logs in, the person in charge of operation has the screen operation authority of all of the HMI screens 17 (G10, G11, and G12). In a case where the person in charge of facility logs in, the person in charge of facility has the screen operation authority of the HMI screen 17 (G11), but does not have the screen operation authority of the HMI screens 17 (G10 and G12).

FIG. 6 is a diagram illustrating an example of the part operation authority (operation place) table 27. The part operation authority (operation place) table 27 includes part operation authority (operation place) information defining presence/absence of the operation authority (operation permission/prohibition) of each of the specific parts displayed on the HMI screens 17, based on the operation places of the HMI client devices 12a and 12b, more specifically, based on the RM operation room 13 and the FM operation room 14 where the HMI client devices 12a and 12b are respectively installed. In the example illustrated in FIG. 6, the HMI client device 12a operated in the RM operation room 13 is not permitted to operate a specific operation part (1_PL) on the HMI screen 17 (G10), but is permitted to operate a specific operation part (3_PL) on the HMI screen 17 (G11). The HMI client device 12b operated in the FM operation room 14 is permitted to operate a specific operation part (1_PL) on the HMI screen 17 (G10), but is not permitted to operate a specific operation part (2_PL) on the HMI screen 17 (G11).

FIG. 7 is a diagram illustrating an example of the part operation authority (duty) table 28. The part operation authority (duty) table 28 includes part operation authority (duty) information defining presence/absence of the operation authority (operation permission/prohibition) of each of the specific parts displayed on the HMI screens 17, based on the duty of the operator logging in the HMI client devices 12, more specifically, based on whether the operator is the person in charge of operation or the person in charge of facility. In the example illustrated in FIG. 7, in the case where the person in charge of operation logs in, the person in charge of operation is permitted to operate the specific operation part (1_PL) on the HMI screen 17 (G11), but is not permitted to operate specific operation parts (4_PL and 5_PL). The specific operation part (1_PL) is, for example, an operation part for performing manual operation (manual intervention). In the case where the person in charge of facility logs in, the person in charge of facility is not permitted to operate the specific operation part (1_PL) on the HMI screen 17 (G11), but is permitted to operate the specific operation parts (4_PL and 5_PL). The specific operation parts (4_PL and 5_PL) are, for example, operation parts for performing maintenance.

Each of the HMI client devices 12 (12a and 12b) includes a processing circuit 30 (30a or 30b) and a monitor 15 (15a or 15b). As illustrated in FIG. 9 described below, each of the processing circuits 30 includes a processor 121 performing various kinds of processing, and a memory 122 storing various kinds of information. The processor 121 and the memory 122 respectively correspond to a client processor and a client memory according to the claims. When the processor 121 executes programs stored in the memory 122, the processor 121 functions as the web browser processing unit 31 (31a or 31b). In the present specification, in a case where reference numerals 30a and 31a are not distinguished from reference numerals 30b and 31b, the reference numerals 30 and 31 are simply used.

The web browser processing units 31 are performed by the respective web browsers 16. Each of the web browsers 16 draws the HMI screen 17 to supervise and control the hot rolling line RL. Each of the HMI screen 17 is switched to another HMI screen 17 in response to operation by the operator. A plurality of parts is arranged in each of the HMI screens 17. The parts include, for example, operation parts (1_PL, 2_PL, 3_PL, . . . ) for transmitting the control signals to the PLCs 8 in response to operation by the operator, display parts changed in display state (numerical value, characters, color, and shape) in response to the received PLC signals, and screen transition parts for switching each of the HMI screens to another HMI screen. The operation parts include the specific operation parts (1_PL, 2_PL, 3_PL, . . . , 5_PL), operation permission/prohibition of which is determined by the part operation authority (operation place) table 27 and the part operation authority (duty) table 28 as described above.

At startup of each of the web browser 16, the corresponding web browser processing unit 31 receives the HTML file, the SVG file 23, the parts library 24, the parts library 24, the screen operation authority (operation place) table 25, the screen operation authority (duty) table 26, the part operation authority (operation place) table 27, the part operation authority (duty) table 28, and the like from the web server processing unit 22, and stores these data in the memory 122. Each of the web browsers 16 (each of web browser processing units 31) obtains the duty of the operator logging in the own HMI client device 12, and stores the duty in the memory 122. The duty of the operator can be obtained by, for example, referring to a group user list in which login IDs and duty of the plurality of operators are collectively registered. Further, based on the data, each of the web browsers 16 draws the HMI screen 17 in which the plurality of parts including the operation parts (including specific operation parts) and the display parts are arranged. Further, at startup, each of the web browsers 16 is executed in a mode not using a cache in order to constantly obtain latest files from the web server processing unit 22.

Each of the web browser processing units 31 reads the screen operation authority (operation place) table 25 received from the HMI server device 11, and determines operation permission/prohibition (presence/absence of the operation authority) of each of the HMI screens 17 based on the operation place for each of the web browsers 16. Further, each of the web browser processing units 31 reads the screen operation authority (duty) table 26 received from the HMI server device 11, and determines operation permission/prohibition (presence/absence of operation authority) of each of the HMI screens 17 based on the duty for each of the web browsers 16.

In addition, each of the web browser processing units 31 reads the part operation authority (operation place) table 27 received from the HMI server device 11, and determines operation permission/prohibition of each of the specific operation parts (1_PL, 2_PL, 3_PL, . . . , 5_PL) on the target HMI screen 17 (for example, G11) based on the operation place for each of the web browsers 16. Further, each of the web browser processing units 31 reads the part operation authority (duty) table 28 received from the HMI server device 11, and determines operation permission/prohibition of each of the specific operation parts (1_PL, 2_PL, 3_PL, . . . , 5_PL) on the HMI screen 17 (G11) based on the duty of the operator logging in the own HMI client device 12.

Moreover, each of the web browser processing units 31 performs screen drawing processing 32. In the screen drawing processing 32, the HMI screen 17 (G11) is drawn on the corresponding web browser 16 by preferentially applying the operation authority (operation permission/prohibition) based on the operation place and the duty of the operator, defined in the part operation authority (operation place) table 27 and the part operation authority (duty) table 28, to each of the specific operation parts (1_PL, 2_PL, 3_PL, . . . , 5_PL) on the HMI screen 17 (G11), and applying the screen operation authority (operation permission/prohibition) defined in the screen operation authority (operation place) table 25 and the screen operation authority (duty) table 26, to operation parts (6_PL, . . . ) other than the specific operation parts on the HMI screen 17.

More specifically, each of the web browser processing units 31 performs the script for each of the part types included in the above-described parts library 24, based on the part types of the parts arranged in the HMI screen 17 (G11). Among the part types, operation parts, operation of which is changed based on the screen operation authority passed to the script and presence/absence (parameter value) of the part operation authority, are described.

As for the operation parts (1_PL, 2_PL, 3_PL, 4_PL, . . . ) , in a case where the web browser 16 is not permitted to operate the HMI screen 17 in the screen operation authority (operation place) table 25 and the screen operation authority (duty) table 26, all of the operation parts arranged in the HMI screen 17 of the web browser 16 are drawn in an inoperable state in principle. In a case where the web browser 16 is permitted to operate the HMI screen 17 in the screen operation authority (operation place) table 25 and the screen operation authority (duty) table 26, all of the operation parts arranged in the HMI screen 17 of the web browser 16 are drawn in an operable state in principle.

In addition, in a case where the operation authority of each of the specific operation parts (1_PL, 2_PL, 3_PL, . . . , 5_PL) in the HMI screen 17 is defined based on the operation place and the duty of the operator in the part operation authority (operation place) table 27 and the part operation authority (duty) table 28, the operation authority defined in the part operation authority (operation place) table 27 and the part operation authority (duty) table 28 is preferentially applied to each of the specific operation parts. As for the operation parts not defined in the part operation authority (operation place) table 27 and the part operation authority (duty) table 28, the operation authority defined in the screen operation authority (operation place) table 25 and the screen operation authority (duty) table 26 is applied.

In the inoperable state, each of the operation parts does not accept execution operation (for example, mouse click) by the operator including the person in charge of operation (operator) and the person in charge of facility. In the operable state, each of the operation parts accepts the execution operation by the operator, and transmits a control signal corresponding to the operation to the HMI server device 11.

When each of the HMI client devices 12 receives the PLC signal from the HMI server device 11, the corresponding web browser processing unit 31 dynamically sets the screen operation authority and the part operation authority for each of the HMI screens 17 displayed on the web browser 16. In this case, the screen operation authority (operation place) table 25, the screen operation authority (duty) table 26, the part operation authority (operation place) table 27, and the part operation authority (duty) table 28 are also referred as described above. Therefore, detailed description is omitted.

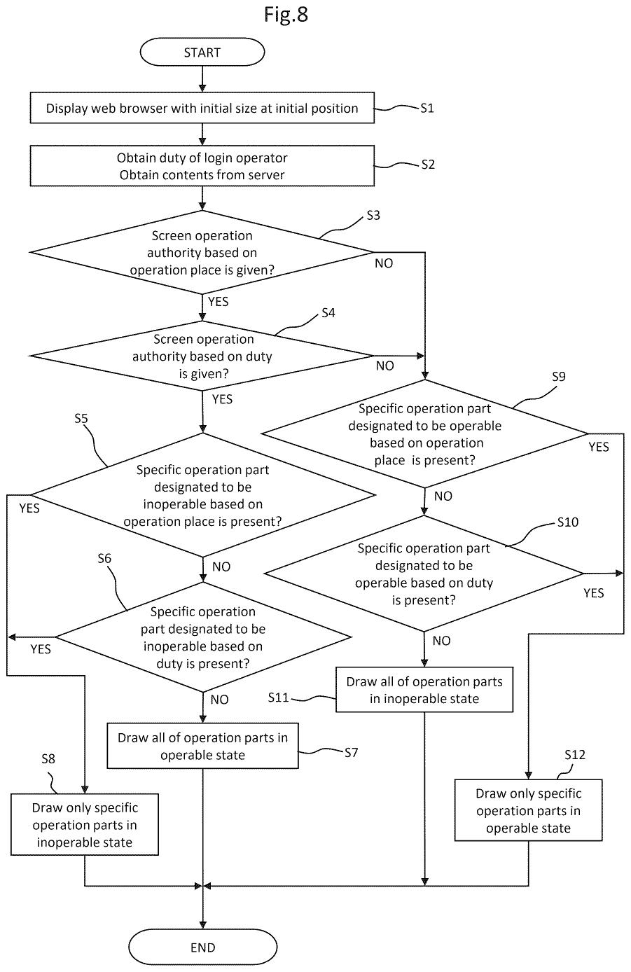

Next, drawing of the HMI screen 17 on each of the web browsers 16 based on presence/absence of the operation authority is specifically described with reference to FIG. 8. FIG. 8 is a flowchart to explain an example of drawing processing in each of the HMI client devices 12.

When the operator logs in any of the HMI client devices 12, a routine illustrated in FIG. 8 is activated. The operator is the person in charge of operation or the person in charge of facility. In step S1, the HMI client device 12 executes (starts up) the web browser 16. The web browser processing unit 31 displays the web browser 16 with a predetermined initial size at a predetermined initial position on the prescribed monitor 15, irrespective of a position and a size when the web browser 16 is ended.

In step S2, the web browser 16 obtains the duty of the login operator from the login ID of the operator, and obtains contents from the HMI server device 12. The contents include the HTML file, the SVG file 23, the parts library 24, the screen operation authority (operation place) table 25, the screen operation authority (duty) table 26, the part operation authority (operation place) table 27, and the part operation authority (duty) table 28 described above. Note that it is sufficient to obtain the parts library 24 and the tables 25 to 28 only at startup of the web browser 16.

In steps S3 to S12, the web browser processing unit 31 draws the designated HMI screen 17 on the web browser 16 based on the screen operation authority (operation place) table 25, the screen operation authority (duty) table 26, the part operation authority (operation place) table 27, and the part operation authority (duty) table 28 obtained in step S2 described above.

The web browser processing unit 31 determines whether the screen operation authority of the HMI screen 17 based on the operation place of the HMI client device 12 has been given, with reference to the screen operation authority (operation place) table 25 (step S3). In a case where the screen operation authority based on the operation place has not been given, the processing proceeds to step S9. In contrast, in a case where the screen operation authority based on the operation place has been given, the processing proceeds to step S4.

In step S4, it is determined whether the screen operation authority of the HMI screen 17 based on the duty obtained in step S2 described above has been given, with reference to the screen operation authority (duty) table 26. In a case where the screen operation authority based on the duty has not been given, the processing proceeds to step S9. In contrast, in a case where the screen operation authority based on the duty has been given, the processing proceeds to step S5.

In step S5, it is determined whether a specific operation part designated to be inoperable based on the operation place is present, with reference to the part operation authority (operation place) table 27. In a case where the specific operation part designated to be inoperable based on the operation place is present, the processing proceeds to step S8. In contrast, in a case where the specific operation part designated to be inoperable based on the operation place is absent, the processing proceeds to step S6.

In step S6, it is determined whether a specific operation part designated to be inoperable based on the duty is present, with reference to the part operation authority (duty) table 28. In a case where the specific operation part designated to be inoperable based on the duty is present, the processing proceeds to step S8. In contrast, in a case where the specific operation part designated to be inoperable based on the duty is absent, the web browser processing unit 31 draws all of the operation parts on the HMI screen 17 in the operable state (step S7). Thereafter, the routine is once ended.

In step S8, the web browser processing unit 31 draws the specific operation parts on the HMI screen 17 in the inoperable state, and draws the operation parts other than the specific operation parts in the operable state (step S8). Thereafter, the routine is once ended.

In step S9, it is determined whether a specific operation part designated to be operable based on the operation place is present, with reference to the part operation authority (operation place) table 27. In a case where the specific operation part designated to be operable based on the operation place is present, the processing proceeds to step S12. In contrast, in a case where the specific operation part designated to be operable based on the operation place is absent, the processing proceeds to step S10.

In step S10, it is determined whether a specific operation part designated to be operable based on the duty is present, with reference to the part operation authority (duty) table 28. In a case where the specific operation part designated to be operable based on the duty is present, the processing proceeds to step S12. In contrast, in a case where the specific operation part designated to be operable based on the duty is absent, the processing proceeds to step S11.

In step S11, the web browser processing unit 31 draws all of the operation parts on the HMI screen 17 in the inoperable state (step S11). Thereafter, the routine is once ended.

In step S12, the web browser processing unit 31 draws the specific operation parts on the HMI screen 17 in the operable state, and draws the operation parts other than the specific operation parts in the inoperable state (step S12). Thereafter, the routine is once ended.

The above-described processing in steps S1 to S12 are performed every time the operator logs in any of the HMI client devices 12 and starts up the web browser 16.

According to the routine described above, in a case where operation of the HMI screen 17 is permitted based on the operation place in the screen operation authority (operation place) table 25, but operation of the specific operation parts is not permitted based on the duty in the part operation authority (duty) table 28, the web browser processing unit 31 draws the specific operation parts in the inoperable state on the web browser 16, and draws the operation parts other than the specific operation parts in the operable state on the web browser 16.

In the above-described flowchart in FIG. 8, drawing of the HMI screen 17 at startup of the web browser 16 is described. This makes it possible to statically set presence/absence of the screen operation authority for each of the HMI screens 17 and presence/absence of the operation authority of each of the operation parts on the HMI screen 17. There is a case where the operator in the login state presses a screen transition button on the HMI screen 17 to transit the HMI screen 17 to another HMI screen 17. In this case, the web browser processing unit 31 newly obtains the HTML file and the SVG file 23 relating to the other HMI screen 17 from the HMI server device 12, and performs the processing in and after step S3. As a result, presence/absence of the screen operation authority for each of the HMI screens 17 and presence/absence of the part operation authority are statically set.

After the screen operation authority and the part operation authority are statically set as described above, when the HMI client device 12 receives the PLC signal from the HMI server device 11, the processing in steps S2 to S12 are performed, and the presence/absence of the screen operation authority for each of the HMI screens 17 and presence/absence of the part operation authority are statically set.

As described above, according to the present embodiment, when the HMI screen 17 is drawn on the web browser 16, operation permission/prohibition defined in the screen operation authority (operation place) table 25 is applied to the plurality of operation parts on the HMI screen 17, and operation permission/prohibition defined based on the duty in the part operation authority (duty) table 28 is preferentially applied to each of the specific operation parts on the HMI screen 17 as well. Accordingly, the operation authority is set for each of the HMI screens 17 based on the operation places of the HMI client devices 12, and the operation authority of each of the specific operation parts is preferentially set for each of the HMI screens 17 based on the duty of the operator. As a result, more precise operation authority is set for each of the HMI screens 17. This makes it possible to prevent safety of the supervised facility devices 2 to 7, furthermore, safety of the hot rolling line RL from being impaired.

FIG. 9 is a block diagram illustrating a hardware configuration example of the HMI server device 11 and one of the HMI client devices 12.

The above-described processing of the HMI server device 11 is realized by a processing circuit. The processing circuit includes the processor 111, the memory 112, and a network interface 113 that are connected to one another. The processor 111 as the server processor realizes the functions of the HMI server device 11 by executing various kinds of programs stored in the memory 112 as the server memory. The memory 112 includes a main storage device and an auxiliary storage device. The memory 112 previously stores the HTML file, the SVG file 23, the parts library 24, the screen operation authority (operation place) table 25, the screen operation authority (duty) table 26, the part operation authority (operation place) table 27, and the part operation authority (duty) table 28 described above. The network interface 113 is communicably connected to other devices in the same network through the information LAN 92.

The above-described processing of each of the HMI client devices 12 is realized by the processing circuit 30. The processing circuit 30 includes the processor 121, the memory 122, a network interface 123, an input interface 124, and the monitor 125 that are connected to one another. The processor 121 realizes the functions of the own HMI client device 12 by executing various kinds of programs stored in the memory 122. The memory 122 includes a main storage device and an auxiliary storage device. The network interface 123 is communicably connected to other devices in the same network through the information LAN 92. The input interface 124 is a set of input devices including a keyboard, a mouse, a touch panel, and the like.

Although the embodiment of the present disclosure is described above, the present disclosure is not limited to the above-described embodiment, and can be variously modified and implemented without departing from the spirit of the present disclosure. For example, in the above-described embodiment, the case where the duty of the operator include the duty relating to operation and the duty relating to facilities is described as an example; however, in addition to the duty relating to operation and the duty relating to facilities, the duty further include duty relating to safety permitted to operate all specific operation parts. Further, the duty relating to operation may be classified into a plurality of duty based on a skill level of manual operation. For example, the person in charge of operation may be classified into a senior operator (senior-level person in charge of operation) high in skill level of manual operation and a junior operator (junior-level person in charge of operation) lower in skill level than the senior operator. The present disclosure is applicable to, for example, a case where the operators are classified into the senior operator, the junior operator, the person in charge of facility, and the person in charge of safety.

For example, in a case where the person in charge of facility does not operate the HMI client devices 12, the operators may be classified into the senior operator high in skill level of manual operation and the junior operator lower in skill level than the senior operator. In this case, it is also possible to limit operation of the specific operation parts by the junior operator. As a result, it is possible to prevent safety of the supervised facility devices, furthermore, safety of the hot rolling line RL from being impaired, as in the above-described embodiment.

In the above-described embodiment, the case where facilities of the hot rolling line RL are supervised is described as an example; however, the embodiment is applicable to a case where facilities of the other industrial plant are supervised.

When numerals of the number, the quantity, the amount, the range, and the like of each of the elements are mentioned in the above-described embodiment, the present disclosure is not limited to the mentioned numerals except for the case of being particularly clearly mentioned and the case of being obviously specified to the numerals in principle. Further, the structure and the like described in the above-described embodiment are not necessarily essential for the present disclosure except for the case of being particularly clearly mentioned and the case of being obviously specified to the structure and the like in principle.

### REFERENCE SIGNS LIST

1 . . . SCADA web HMI system, 2 . . . heating furnace, 3 . . . roughing mill, 4 . . . intermediate facility, 5 . . . finishing mill, 6 . . . water-cooling device, 7 . . . coiler, 8 . . . PLC, 91 . . . control LAN, 92 . . . information LAN, 10 . . . computer, 11 . . . HMI server device, 12,12a, 12b . . . HMI client device, 13 . . . RM operation room, 14 . . . FM operation room, 15,15a,15b . . . monitor, 16,16a,16b . . . web browser, 17,17a, 17b . . . HMI screen, 21 . . . PLC signal processing unit, 22 . . . web server processing unit, 23 . . . SVG file, 24 . . . parts library, 25 . . . screen operation authority (operation place) table, 26 . . . screen operation authority (duty) table, 27 . . . part operation authority (operation place) table, 28 . . . part operation authority (duty) table, 20,30a,30b . . . processing circuit, 31,31a, 31b . . . , 32,32a,32b . . . , 111,121 . . . processor, 112,122 . . . memory, 113,123 . . . network interface, 124 . . . input interface, RL . . . hot rolling line, Mr . . . material to be rolled, G10,G11,G12 . . . screen name, RM1_1,RM1_2,FM1_1,FM1_2 . . . browser name, 1_PL, 2_PL, 3_PL, 4_PL, 5_PL . . . operation part, 1_PL, 2_PL, 3_PL, 4_PL, 5_PL . . . specific operation part

1. A SCADA web HMI system comprising an HMI server device configured to execute a web server, and a plurality of HMI client devices each configured to execute at least one web browser communicating with the web server, wherein
the HMI server device includes a server processor and a server memory,
the server memory stores image data on an HMI screen for supervising an industrial plant, screen operation authority information, and part operation authority information,
the screen operation authority information defines operation permission/prohibition of the HMI screen for each HMI screen displayed on the web browser, based on operation places of the HMI client devices,
the part operation authority information defines operation permission/prohibition of each of specific operation parts as a part of a plurality of operation parts on the HMI screen, for each HMI screen displayed on the web browser, based on duty of an operator of the HMI client devices,
the server processor is configured to execute the web server capable of transmitting the image data, the screen operation authority information, and the part operation authority information to the web browser,
each of the HMI client devices includes a client processor, a client memory, and a monitor,
the client memory stores the image data, the screen operation authority information, and the part operation authority information received from the web server, and
the client processor is configured to
execute the web browser displayed on the monitor, and
perform screen drawing processing for drawing the HMI screen on the web browser by applying the operation permission/prohibition defined in the screen operation authority information to the plurality of operation parts on the HMI screen and preferentially applying the operation permission/prohibition defined based on the duty in the part operation authority information, to each of the specific operation parts on the HMI screen.

2. The SCADA web HMI system according to claim 1, wherein
the screen operation authority information further defines the operation permission/prohibition of the HMI screen for each HMI screen displayed on the web browser, based on the duty of the operator of the HMI client devices, and
the part operation authority information further defines the operation permission/prohibition of each of the specific operation parts as a part of the plurality of operation parts on the HMI screen, for each HMI screen displayed on the web browser, based on the operation places of the HMI client devices.

3. The SCADA web HMI system according to claim 1, wherein,
in the screen drawing processing,
in a case where operation of the HMI screen on the web browser is permitted in the screen operation authority information, and operation of the specific operation parts on the web browser is not permitted in the part operation authority information,
the specific operation parts are drawn in an inoperable state on the web browser, and
the operation parts other than the specific operation parts among the plurality of operation parts are drawn in an operable state on the web browser.

4. The SCADA web HMI system according to claim 1, wherein,
in the screen drawing processing,
in a case where operation of the HMI screen on the web browser is not permitted in the screen operation authority information, and operation of the specific operation parts on the web browser is permitted in the part operation authority information,
the specific operation parts are drawn in an operable state on the web browser, and
the operation parts other than the specific operation parts among the plurality of operation parts are drawn in an inoperable state on the web browser.

5. The SCADA web HMI system according to claim 2, wherein,
in the screen drawing processing,
in a case where operation of the HMI screen on the web browser is permitted in the screen operation authority information, and operation of the specific operation parts on the web browser is not permitted in the part operation authority information,
the specific operation parts are drawn in an inoperable state on the web browser, and
the operation parts other than the specific operation parts among the plurality of operation parts are drawn in an operable state on the web browser.

6. The SCADA web HMI system according to claim 2, wherein,
in the screen drawing processing,
in a case where operation of the HMI screen on the web browser is not permitted in the screen operation authority information, and operation of the specific operation parts on the web browser is permitted in the part operation authority information,
the specific operation parts are drawn in an operable state on the web browser, and
the operation parts other than the specific operation parts among the plurality of operation parts are drawn in an inoperable state on the web browser.
